(19) United States
(12) Patent Application Publication
(10) Pub. No.: US 2014/0227166 A1
(43) Pub. Date: Aug. 14, 2014

(54) Catalyst for H202 synthesis and method for preparing such catalyst

(71) Applicants: Frederique Desmedt, Brussels (BE); Yves Vlasselaer, Leefdaal (BE)

(72) Inventors: Frederique Desmedt, Brussels (BE); Yves Vlasselaer, Leefdaal (BE)

(73) Assignee: SOLVAY SA, Brussels (BE)

(21) Appl. No.: 14/343,405

(22) PCT Filed: Sep. 6, 2012
(86) PCT No.: PCT/EP2012/067429

§ 371 Date: Mar. 7, 2014

(30) Foreign Application Priority Data
Sep. 16, 2011 (EP) 11181707.8

(51) Int. Cl. B01J 31/02; C01B 15/029

(52) U.S. Cl. CPC B01J 31/0275; C01B 15/029
USPC 423/584; 502/325; 502/339; 502/261; 502/150; 502/168

(57) ABSTRACT

A catalyst comprising at least one catalytically active metal selected from the group consisting of elements of Groups 7 to 11, wherein the catalytically active metal is supported on a support material being grafted with acid groups other than OH groups, wherein a metal is in the bulk of the support material, and wherein the catalytically active metal is different from the metal of the support material. A method for preparing such catalyst and the use of such catalyst for catalyzing reactions.

This application claims the priority of the European application No. 11181707.8 filed on Sep. 16, 2011, the whole content of this application being incorporated herein by reference for all purposes.

### FIELD OF THE INVENTION

The present invention relates to a catalyst comprising at least one catalytically active metal selected from elements in Groups 7 to 11, wherein the catalytically active metal is supported on a support material being grafted with acid groups other than OH groups and wherein the catalytically active metal is different from the metal of the support material. The invention further relates to a method for preparing said catalyst and the use of said catalyst for catalyzing reactions.

### BACKGROUND

Hydrogen peroxide is widely used in almost all industrial areas, particularly in the chemical industry and environmental protection. The only degradation product of its use is water, and thus it has played a large role in environmentally friendly methods in the chemical industry. Hydrogen peroxide is produced on an industrial scale by the anthraquinone oxidation process. However, this process can hardly be considered as green method. Therefore, the direct synthesis of hydrogen peroxide from oxygen and hydrogen using a variety of catalysts has gained increased importance.

In the direct synthesis of hydrogen peroxide the working solution is hydrogenated over a catalyst generally at a temperature of 40° C. to 50° C. The extent of hydrogenation must be carefully controlled and generally kept under 60% to minimize secondary hydrogenation reactions. For example, nickel and supported palladium catalysts have been used in the hydrogenation step.

Acidic supports are often used to reduce the required concentration of inorganic acid in the reaction medium. Among the solid acids, regularly cited examples include a superacid consisting of tungsten oxide on a zirconia substrate, acidic supports such as molybdenum oxide on zirconia, vanadium oxide on zirconia, supported sulfuric acid catalysts, and fluorinated alumina. However, only low yields of hydrogen peroxide are obtained with these methods.

Better yields have been reported with neutral solutions and heterogeneous catalysts consisting of functionalized carbons with sulfonic acid groups, or sulfonic acid functionalized polystyrene resins. Catalysts prepared by ankering Pd^{II} ions onto sulfonic acid functionalized polystyrene ion-exchange resins are reported to be highly effective for the direct synthesis of hydrogen peroxide with methanol as solvent at 40° C.

In this regard US 2008/0299034 A1 discloses a catalyst comprising at least one noble or semi-noble metal, wherein the catalyst is supported on an inorganic material functionalized with acid groups, such as silica functionalized with sulfonic groups. It is said that these catalysts are easily prepared, are reproducible and have a high mechanical resistance and large specific surface area.

However, it has been observed that the selectivity of the catalyst known from US 2008/0299034 A1 decreases slowly while the hydrogen peroxide concentration in the reaction medium is increasing. Thus, there remains a need for further improving the known catalysts.

Lunsford and co-workers discuss in Catal. Lett. (2009) 132, 342-348 the catalytic behavior of Pd⁰/SiO₂, PdO/SiO₂ and partially reduced PdO/SiO₂ in the direct formation of hydrogen peroxide from hydrogen and oxygen.

Strukul and co-workers report the testing of palladium catalysts supported on SO₄²⁻, Cl⁻, F⁻, and Br⁻ doped zirconia (Journal of Catalysis 239 (2006) 422-430). Surface-oxidized Pd⁰ catalysts are said to show high catalytic activity and the highest selectivity.

Yamashita and co-workers suggest in J. Phys. Chem. Lett. (2010), 1, 1675-1678 that an acidic resin bearing SO₃H functional groups within its reticular structure acts as a support for the in situ formation of active Pd nanoparticles responsible for the direct synthesis of hydrogen peroxide from hydrogen and oxygen.

According to Fierro and co-workers, the active species for the hydrogen peroxide direct synthesis is Pd(2+) in interaction with SO₃H groups (Chem. Comm. (2004) 1184-1185). PdO is said to be not active and Pd(0) clusters, formed from PdO species during reaction are said to catalyze the hydrogen peroxide decomposition into water.

Corain and co-workers have broadly studied the direct synthesis of hydrogen peroxide on Pd(0) and Pd(0)-Au(0) nanoclusters on acid ion exchange resins (Applied Catalysis A: General 358 (2009) 224-231 and Adv. Synth. Catal. (2006) 348, 255-259). Their analysis is opposed to the one of Fierro and co-workers. For them, the activity of the catalyst is mainly due to Pd(0) nanoclusters. Following Corain and co-workers, Pd(2+) is reduced during the reaction in presence of methanol.

While the above described prior art is contradictory, the present inventors have found that Pd(2+) is indeed an active species for the direct synthesis of hydrogen peroxide. However, it was also surprisingly found that its reduction during the reaction with methanol as suggested by Corain and co-workers has an adverse effect because the selectivity of the catalyst is not stable.

Therefore, the present invention relates to the problem of providing further catalysts, in particular catalysts suitable for the industrial preparation of hydrogen peroxide by direct synthesis, which do not exhibit the above drawbacks, in particular which have a selectivity which remains constant even when the hydrogen peroxide concentration increases.

### BRIEF DESCRIPTION OF THE DRAWING

FIG. 1 shows the selectivity of a catalyst according to the invention.

### DESCRIPTION OF THE INVENTION

It has now surprisingly been found that the above problems can be solved by partially reducing the catalytically active metal which is attached on a support material being grafted with acid groups prior to the first use of the catalyst. It was surprisingly observed that the selectivity of such pretreated catalyst remains stable during its further use in the direct synthesis of hydrogen peroxide and that this beneficial effect occurs if the metal is reduced before the first use of the catalyst but not with a catalyst wherein the catalytically active metal is reduced in situ during its use in the direct synthesis of hydrogen peroxide. While the experiments of the present inventors confirmed the above prior art teaching that during hydrogen peroxide direct synthesis the catalytically active metal can be partially reduced by the action of methanol, it was also surprisingly found that such catalyst wherein the catalytically active metal is reduced in situ during use of the catalyst does not result in a stable selectivity. Only reduction of the catalytically active metal in the catalyst prior to its first use in hydrogen peroxide direct synthesis shows the desired beneficial effect on the stability of the catalyst selectivity.

While applicants do not wish to be bound to any theory, it is believed that reduction of the catalytically active metal in a hydrogen atmosphere prior to the first use of the catalyst results in a different metal species, for example with regard to size and surface structure of the nanoparticles, compared to the reduction of the catalytically active metal during hydrogen peroxide direct synthesis in the presence of hydrogen, oxygen and methanol. It is believed that this difference results in the increased stability in the catalyst selectivity.

It was furthermore found that there is a synergistic effect on the stability of the selectivity of the catalyst within a certain ratio of reduced Pd (metallic and/or hydride) to Pd^{II} on the support. It was found that if the concentration of reduced Pd on the support is too low then the beneficial effect on the selectivity of the catalyst does not occur and if the concentration of reduced Pd on the catalyst is too high, the selectivity of the catalyst decreases.

Thus, the present invention relates to a catalyst comprising at least one catalytically active metal selected from elements in Groups 7 to 11, wherein the catalytically active metal is supported on a support material being grafted with acid groups other than OH groups and wherein the catalytically active metal is different from the metal of the support material, characterized in that in the fresh catalyst between 1% and 70% of the catalytically active metal, based on the total amount of the catalytically active metal present, is present in reduced form as determined by XPS.

In the catalyst according to the invention the support material is grafted with acid groups. In this context “grafted” means that the acid groups are attached to the support material by a covalent bond.

The acid groups with which the support material is grafted are groups other than OH groups. OH groups are excluded because some support materials, such as inorganic oxide, may have acidic hydroxyl groups. Within the scope of the present invention it is, however, intended that the support material has acid groups in addition to the naturally occurring hydroxyl groups and being different to these groups. Preferably, the support material is grafted with organo-acid groups.

Furthermore, it is to be distinguished between the catalytically active metal being supported on the support material and the metal being part of the support material, such as the metal in the inorganic oxide forming the support material. Thus, the catalytically active metal being supported on the support material is different from the metal of the support material. In this context “the metal of the support material” refers to the metal in the bulk of the support material, such as silicium in silica or titanium in titania. Any impurities possibly present in the support material are not considered as “the metal of the support material”.

In the catalyst according to the invention between 1% and 70% of the catalytically active metal is present in reduced form. As described above, it is important that reduction of the catalytically active metal occurs prior to the first use of the catalyst in hydrogen peroxide direct synthesis. Therefore, the catalyst is characterized in that in the fresh catalyst between 1% and 70% of the catalytically active metal is present in reduced form. In this context “fresh catalyst” means that the catalyst has not yet been used in hydrogen peroxide direct synthesis or any other catalyzed reaction.

In prior art catalysts the catalytically active metal is present in oxidized form, for example as Pd^{II}. The invention is based on the finding that if this metal is partially reduced prior to the first use of the catalyst the selectivity of the catalyst remains constant during reaction and in particular even when the hydrogen peroxide concentration in the reaction medium increases. Thus, in the context of the present invention a metal in reduced form means metal atoms having the oxidization level 0 or lower, such as Pd⁰ or Pd hydride.

The catalytically active metal which may be used in the catalyst of the present invention can be selected by a person skilled in the art according to the intended use of the catalyst. For example, the metal can be selected from palladium, platinum, silver, gold, rhodium, iridium, ruthenium, osmium, and combinations thereof. In a more preferred embodiment, the catalyst comprises palladium as the catalytically active metal or the combination of palladium with another metal (for example, gold).

It is important that the ratio of reduced metal to oxidized metal on the support material is in the range being effective to maintain the selectivity of the catalyst constant over the reaction time without decreasing the overall selectivity. It has been found that this effect is achieved if between 1% and 70% of the catalytically active metal, based on the total amount of the metal present, is present in reduced form. Preferably between 10% and 40% of the catalytically active metal, based on the total amount of the metal present, is present in reduced form. For example, for palladium good results are achieved when between 20% and 30%, such as between 25% and 30% of the palladium, based on the total amount of the palladium present, is present in reduced form.

In the context of the present application the amounts of reduced metal and oxidized metal are measured by XPS analysis. Prior to measuring the catalyst is crushed and the obtained powder is compressed into tablets in order to provide an average of the concentrations of oxidized and reduced metal in the outer and more inner parts of the catalyst. Furthermore, this sample preparation reduces the influence of particle size and particle distribution. It can nevertheless become necessary to repeat the XPS measurement with samples being crushed to smaller particle size until a reproducible value is obtained.

It is furthermore important to use monochromatic Al radiation because other radiations, such as non-monochromatic Mg radiation, is known to induce partial reduction of the metal oxide during measurement.

The XPS analysis procedure will be explained in more detail below.

The amount of catalytically active metal supported on the support material is not specifically limited and can be selected by a person skilled in the art according to the requirements. For example, the amount of metal can be 0.001% to 10% by weight, preferably 0.1% to 5% by weight, more preferably 0.1% to 2% by weight, calculated as metal in reduced form based on the total weight of the support material.

Any suitable support material can be used in the catalyst according to the invention. For example, the support material can be an inorganic or organic material. As inorganic materials inorganic oxides can be used. For example, the inorganic oxide can be selected from elements in Groups 2 to 14, such as SiO₂, Al₂O₃, zeolites, B₂O₃, GeO₂, Ga₂O₃, ZrO₂, TiO₂, MgO, and mixtures thereof. The preferred inorganic oxide is SiO₂. The metal from the inorganic carrier is different from the catalytically active metal for the hydrogen peroxide direct synthesis.

In one embodiment the support material used in the invention has a large specific surface area of for example above 20 m²/g calculated by the BET method, preferably greater than 100 m²/g. The pore volume of the support material can be for example in the range 0.1 to 3 ml/g.

The support materials used can essentially be amorphous like a silica gel or can be comprised of an orderly structure of mesopores, such as, for example, of types including MCM-41, MCM-48, SBA-15, or a crystalline structure, like a zeolite.

Alternatively the support material can be an organic material, such as for example an organic resin or active carbon. As organic resin any known ion exchange resin can be exemplified. Suitable resins can, for example, be polystyrene resins. As active carbon, for example, carbon nanotubes can be used.

The support material used in the catalyst according to the invention is grafted with acid groups (covalently bonded). Preferably the acid groups are grafted onto the support material, i.e. bonded to its surface. The acid groups, which preferably are organo-acid groups, may be selected from among the compounds comprised of sulfonic, phosphonic and carboxylic groups. The acid group more preferably being sulfonic, such as para-toluene sulfonic group, propyl sulfonic group and poly(styrene sulfonic group).

The incorporation of said acid groups during or after synthesis of the support material is known to a person skilled in the art and can be conducted at an industrial scale.

In a particularly preferred embodiment of the present invention the catalyst comprises palladium as metal and the support material is silica grafted with para-toluene sulfonic groups. In this embodiment preferably between 10% and 40%, more preferably between 20% and 30%, most preferably between 25% and 30% of the palladium, based on the total amount of the palladium present, is present in reduced form.

The present invention furthermore relates to a method for preparing the above described catalyst. In this method the support material being grafted with acid groups other than OH groups is contacted with a solution of a metal salt, wherein the metal is selected from elements of Groups 7 to 11 and wherein the metal is different from the metal of the support material, and subsequently 1% to 70% of the metal deposited on the support, based on the total amount of the metal deposited, is reduced. Contacting the support material with a solution of the metal salt can be accomplished in a usual manner, such as for example by immersing the support material into a solution of the metal salt. Alternatively the support material may be sprayed with the solution or otherwise impregnated.

Any type of salt which is soluble in the selected solvent can be used. For example acetates, nitrides, halides, oxalates, etc. are suitable. Preferably the support material is contacted with a solution of palladium acetate.

After the metal has been deposited on the support material, the product is recovered, for example by filtration, washed and dried. Subsequently 1% to 70% of the metal deposited on the support is reduced, for example by using hydrogen at elevated temperature. This hydrogenation step can be carried out for example at a temperature of 100° C. to 140° C. for 1 to 6 hours. Temperature and duration of the hydrogenation step are selected such that the desired amount of metal is reduced.

The catalysts according to the invention are suitable for catalyzing various reactions, including for example hydrogenation or cyclization reactions. Preferably the catalyst is used for catalyzing the synthesis of hydrogen peroxide, in particular for catalyzing the direct synthesis of hydrogen peroxide.

Should the disclosure of any patents, patent applications, and publications which are incorporated herein by reference conflict with the description of the present application to the extent that it may render a term unclear, the present description shall take precedence.

The invention will now be illustrated in more detail by way of the following examples which are not intended to be construed as being limiting.

### EXAMPLES

### Preparation of the Catalyst (General Recipe)

20.14 g of Silicycle Tosic acid (R60530B) was put in a glass reactor of 1 L. 300 ml acetone high grade were added to the solid. The suspension was mechanically stirred at room temperature at around 250 rpm.

0.247 g of palladium acetate was dissolved at room temperature in 100 ml of acetone high grade.

The Pd solution was added slowly to the suspension (around 1 ml/5 sec).

The suspension was maintained under mechanical stirring during 4 hours at room temperature.

The suspension was filtered under vacuum and washed with 100 ml acetone high grade.

The solid was dried 24 hours at 60° C.

The solid was hydrogenated at 120° C. during three hours (hydrogen was diluted with nitrogen).

### XPS Analysis Procedure

Sample preparation: samples prepared as compressed tablets of powder which has been crushed (ground) in a mortar. Samples are stored in closed vials until measurement.
Spectrometer: Phi VersaProbe 5000
Chamber vacuum: 1.10⁻⁹ Torr
X-ray source: monochromatic Al Kₐₗₚₕₐ (E=1486.6 eV)
X-ray power: 50 W
Beam voltage: 15000 V
Analyzed area: 200 μm diameter
Charge neutralization: argon ion source (2.4 eV, 20 mA)
Pass energy: 117.4 eV for the survey and 23.5 eV for the high resolution scans
Scanning time: 14 min to 250 min, depending on the X-ray line; for Pd3d, 235 min to 250 min.

### Data Treatment

Binding energy reference: carbon (285 eV)
Background subtraction: Shirley
Pd3d fitting: mixed Gaussian-Lorentzian lines, with Gaussian percentage in the 70%-100% range.
Pd3d(5/2) peak was fitted by two components, located around 335.9 eV and 337.8 eV, and assigned to metallic (or hydride) Pd and palladium oxide, respectively.

### Examples of Catalysts Preparation

### Catalyst A

Catalyst A has been prepared as described in the above general recipe.

Pd amount on the catalyst was 0.59% Wt.

An XPS analysis has been done.

Results are in relative %:

| | Catalyst |
|---|---|
| Nanoparticles Pd⁰ and/or hydride | 27.2 (336 eV) |
| Nanoparticles Pd^{II} | 77.8 (338.2 eV) |

### Catalyst B

Catalyst B has been prepared in similar conditions than catalyst A. The only differences are:
Contact time between the Silicycle and the Pd acetate solution: overnight instead of 4 hours
Drying temperature: 75° C. instead of 60° C.

Pd amount on the catalyst was 0.49% Wt.

### Catalyst C

Catalyst C has been prepared in similar conditions than catalyst A. The only difference was the hydrogenation conditions: Catalyst C has been hydrogenated at 200° C. during 24 h.

Pd amount on the catalyst was 0.51% Wt.

An XPS analysis has been done.

Results are in relative %:

| | Catalyst |
|---|---|
| Nanoparticles Pd⁰ and/or hydride | 86.3 (336.1 eV) |
| Nanoparticles Pd^{II} | 13.7 (338 eV) |

### Catalyst D

Catalyst D has been prepared as described in the above general recipe. The only difference was the drying temperature of 85° C.

Pd amount on the catalyst was 0.67% Wt.

### Catalyst E

Catalyst E has been prepared in similar conditions than catalyst A. The only difference were the hydrogenation conditions: Catalyst E has been hydrogenated at 120° C. during 3h but with a higher hydrogen flow.

Pd amount on the catalyst was 0.49% Wt.

An XPS analysis has been done.

Results are in relative %:

| | Catalyst |
|---|---|
| Nanoparticles Pd⁰ and/or hydride | 72.2 (335.9 eV) |
| Nanoparticles Pd^{II} | 22.8 (337.6 eV) |

### Catalyst F

Catalyst F has been prepared in similar conditions than catalyst A. The only difference was that no hydrogenation of the catalyst has been done.

Pd amount on the catalyst was 0.73% Wt.

### Catalysts Ga, Gb and Gc

Catalyst G has been prepared in similar conditions than catalyst A. It has been hydrogenated at 150° C. but during different times for obtaining different ratios Pd⁰/Pd^{II}

Pd amount on the catalyst was 0.50% Wt.

An XPS analysis has been done.

Results are in relative %:

| | Catalyst Ga | Catalyst Gb | Catalyst Gc |
|---|---|---|---|
| Nanoparticles | 54.6 (335.9 eV) | 72.4 (335.8 eV) | 89.1 (335.8 eV) |
| Pd⁰ and/or | | | |
| hydride | | | |
| Nanoparticles | 45.4 (337.8 eV) | 27.6 (337.2 eV) | 10.9 (337.3 eV) |
| Pd^{II} | | | |

### Direct Synthesis of Hydrogen Peroxide

In a 380 cc Hastelloy B22 reactor, methanol (220 g), Hydrogen bromide (25 ppm) and catalyst (5.97 g) were introduced.

The reactor was cooled to 5° C. and the working pressure was at 50 bars.

The reactor is flushed all the time of the reaction with the mix of gases: Hydrogen (3.03% Mol)/Oxygen (54.86% Mol)/Nitrogen (42.11% Mol).

When the gas phase out was stable (GC on line), the mechanical stirrer is started at 1500 rpm.

GC on line analyzes every 10 minutes the gas phase out.

Liquid samples were taken to measure hydrogen peroxide and water concentration.

Hydrogen peroxide was measured by redox titration with cerium sulfate.

Water was measure by Karl-Fisher.

### EXAMPLES 1 AND 2

### Catalyst A & Catalyst B

| | | Catalyst A | Catalyst B |
|---|---|---|---|
| Methanol | g | 220 | 221.12 |
| HBr | ppm | 25 | 25 |
| Catalyst | g | 5.9716 | 7.1878 |
| Temperature | ° C. | 5 (8° C. inside) | 5 (8° C. inside) |
| Pressure | bar | 50 | 45 |
| Hydrogen | % Mol | 3.03% | 3.03% |
| Oxygen | % Mol | 54.86% | 54.86% |
| Nitrogen | % mol | 42.11% | 42.11% |
| Speed | rpm | 1200 | 1200 |
| Contact time | Min | 240 | 340 |
| Hydrogen peroxide fin | % Wt | 7.88 | 9.84 |
| Water fin | % Wt | 3.08 | 2.97 |
| Conversion fin | % | 59.6 | 61.9 |
| Selectivity fin | % | 58.4 | 64.5 |
| Productivity fin | mol H₂O₂/ | 3619 | 2795 |
| | (kg of Pd * h) | | |

### EXAMPLES 3, 4 AND 5

### Catalysts Ga, Gb and Gc

| | | Catalyst Ga | Catalyst Gb | Catalyst Gc |
|---|---|---|---|---|
| Methanol | g | 150.22 | 150.46 | 151.01 |
| HBr | ppm | 9.3 | 9.3 | 9.3 |
| Catalyst | g | 3.0075 | 3.0070 | 3.0033 |
| Temperature | ° C. | 5 | 5 | 5 |
| Pressure | bar | 50 | 50 | 50 |
| Hydrogen | % Mol | 3.0 | 3.0 | 3.0 |
| Oxygen | % Mol | 54.9 | 54.9 | 54.9 |
| Nitrogen | % mol | 42.1 | 42.1 | 42.1 |
| Speed | rpm | 1500 | 1500 | 1500 |
| Contact | Min | 300 | 300 | 300 |
| time | | | | |
| H2O2 fin | % Wt | 6.8 | 5.9 | 4.5 |
| Water fin | % Wt | 2.9 | 4.2 | 3.7 |
| Conversion | % | 35 | 40 | 36 |
| fin | | | | |
| Selectivity | % | 56 | 51 | 40 |
| fin | | | | |
| Productivity | mol H₂O₂/(kg | 4067 | 3555 | 2721 |
| fin | of Pd * h) | | | |

The best result is obtained for the catalyst with a low reduced Pd content (Ga). Selectivity is higher; the final concentration of hydrogen peroxide is 1% higher and the final water content lower. The lowest selectivity is obtained for the catalyst with a high Pd0 content: Gc.

### COMPARATIVE EXAMPLE 1

### Catalyst C & Catalyst E

| | | Catalyst C | Catalyst E |
|---|---|---|---|
| Methanol | g | 220.73 | 220.25 |
| HBr | ppm | 25 | 25 |
| Catalyst | g | 7.1875 | 6.6416 |
| Temperature | ° C. | 5 (8° C. inside) | 5 (8° C. inside) |
| Pressure | bar | 45 | 50 |
| Hydrogen | % Mol | 3.6% | 3.6% |
| Oxygen | % Mol | 55% | 55% |
| Nitrogen | % mol | 41.4% | 41.6% |
| Speed | rpm | 1200 | 1200 |
| Contact time | Min | 600 | 360 |
| Hydrogen peroxide fin | % Wt | 8.89 | 2.90 |
| Water fin | % Wt | 10.05 | 2.81 |
| Conversion fin | % | 31.8 | 47.3 |
| Selectivity fin | % | 31.9 | 35.4 |
| Productivity fin | mol H₂O₂/ | 1825 | 890 |
| | (kg of Pd * h) | | |

### COMPARATIVE EXAMPLE 2

### Catalyst A & Catalyst D

| | | Catalyst A | Catalyst D |
|---|---|---|---|
| Methanol | g | 220 | 220 |
| HBr | ppm | 25 | 25 |
| Catalyst | g | 5.9716 | 5.8758 |
| Temperature | ° C. | 5 (8° C. inside) | 40 |
| Pressure | bar | 50 | 50 |
| Hydrogen | % Mol | 3.03% | 3.03% |
| Oxygen | % Mol | 54.86% | 54.86% |
| Nitrogen | % mol | 42.11% | 42.11% |
| Speed | rpm | 1200 | 1200 |
| Contact time | Min | 240 | 300 |
| Hydrogen peroxide fin | % Wt | 7.88 | 8.22 |
| Water fin | % Wt | 3.08 | 8.00 |
| Conversion fin | % | 59.6 | 77.6 |
| Selectivity fin | % | 58.4 | 35.6 |
| Productivity fin | mol H₂O₂/ | 3619 | 3017 |
| | (kg of Pd * h) | | |

### COMPARATIVE EXAMPLE 3

### Catalyst A & Catalyst F

| | | Catalyst A | Catalyst F |
|---|---|---|---|
| Methanol | g | 220 | 220 |
| HBr | ppm | 25 | 25 |
| Catalyst | g | 5.9716 | 6.3006 |
| Temperature | ° C. | 5 (8° C. inside) | 40 |
| Pressure | bar | 50 | 50 |
| Hydrogen | % Mol | 3.03% | 3.03% |
| Oxygen | % Mol | 54.86% | 54.86% |
| Nitrogen | % mol | 42.11% | 42.11% |
| Speed | rpm | 1200 | 1200 |
| Contact time | Min | 240 | 300 |
| Hydrogen peroxide fin | % Wt | 7.88 | 9.74 |
| Water fin | % Wt | 3.08 | 6.9 |
| Conversion fin | % | 59.6 | 75.2 |
| Selectivity fin | % | 58.4 | 43.1 |
| Productivity fin | mol H₂O₂/(kg of | 3619 | 3574 |
| | Pd * h) | | |

The above data demonstrates that for catalysts A and B, which are according to the invention, the conversion and productivity is good and at the same time the selectivity of the catalysts is excellent. For catalysts C and E (comparative example 1), which are not according to the invention, the selectivities are only low.

The above comparison of catalysts A and D (comparative example 2) demonstrate that with catalyst A, which is according to the invention, the direct synthesis of hydrogen peroxide can be carried out by a comparably low temperature of only 8° C. at good conversion, high productivity and high selectivity.

Finally, catalyst A, which is according to the invention, is compared with catalyst F, which is not according to the invention (comparative example 3). Catalyst F was prepared according to the disclosure of US 2008/0299034. It contains Pd^{II} but no reduced palladium. Selectivity and productivity of the catalyst of the present invention is higher compared to the prior art catalyst.

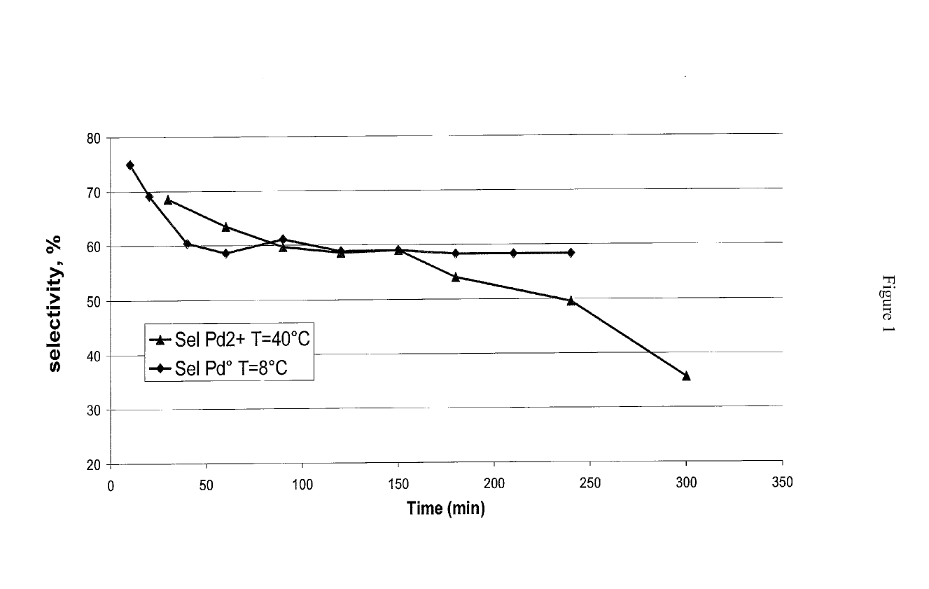

The beneficial technical effect of the catalyst according to the invention is also demonstrated by attached FIG. 1 which shows the selectivity of a catalyst according to the invention at a reaction temperature of 8° C. (“Sel Pd reduced”) compared to the selectivity of a prior art catalyst containing only oxidized palladium at a temperature of 40° C. (“Sel Pd^{II}”). It is evident from FIG. 1 that the selectivity of the catalyst of the present invention is stable even when the concentration of hydrogen peroxide is higher than 6% by weight and even up to 8% by weight, which is obtained after 240 minutes. In contrast thereto the final selectivity of the prior art catalyst observed at 240 minutes is lower than 50% and further decreases with an increasing hydrogen peroxide concentration.

1. A catalyst comprising at least one catalytically active metal selected from the group consisting of elements of Groups 7 to 11, wherein the catalytically active metal is supported on a support material being grafted with acid groups other than OH groups, wherein a metal is in the bulk of said support material, wherein the catalytically active metal is different from the metal of the support material, wherein in said catalyst when fresh, between 1% and 70% of the catalytically active metal, based on the total amount of the catalytically active metal present, is present in reduced form as determined by XPS.

2. The catalyst according to claim 1, wherein the catalytically active metal is selected from the group consisting of palladium, platinum, silver, gold, rhodium, iridium, ruthenium, osmium, and combinations thereof.

3. The catalyst according to claim 2, wherein the catalytically active metal is palladium or a combination of palladium with another metal.

4. The catalyst according to claim 1, wherein in said catalyst when fresh, between 10% and 40% of the catalytically active metal, based on the total amount of the catalytically active metal present, is present in reduced form.

5. The catalyst according to claim 1, wherein the amount of the catalytically active metal is from 0.001% to 10% by weight calculated as catalytically active metal in reduced form and based on the total weight of the support material.

6. The catalyst according to claim 1, wherein the support material is an inorganic oxide of an element selected from the group consisting of elements of Groups 2 to 14.

7. The catalyst according to claim 6, wherein the inorganic oxide is selected from the group consisting of SiO₂, Al₂O₃, zeolites, B₂O₃, GeO₂, Ga₂O₃, ZrO₂, TiO₂, MgO, and mixtures thereof.

8. The catalyst according to claim 7, wherein the inorganic oxide is SiO₂.

9. The catalyst according to claim 1, wherein the support material is an organic material.

10. The catalyst according to claim 1, wherein the acid groups are selected from the group consisting of sulfonic groups, phosphonic groups, carboxylic groups, and mixtures thereof.

11. The catalyst according to claim 1, wherein the catalytically active metal is palladium, and wherein the support material is silica grafted with para-toluene sulfonic groups.

12. The catalyst according to claim 11, wherein in said catalyst when fresh, between 10% and 40% of the palladium, based on the total amount of the palladium present, is present in reduced form.

13. A method for preparing the catalyst according to claim 1, comprising:
contacting a support material being grafted with acid groups other than OH groups with a solution of a catalytically active metal salt, wherein the catalytically active metal is selected from the group consisting of elements of Groups 7 to 11, wherein a metal is in the bulk of said support material, and wherein the catalytically active metal is different from the metal of the support material, and
subsequently reducing from 1% to 70% of the catalytically active metal deposited on the support material, based on the total amount of the catalytically active metal deposited.

14. The method according to claim 13, wherein the reduction step is carried out using hydrogen at elevated temperature.

15. The method according to claim 14, wherein the hydrogenation is carried out at a temperature of from 100° C. to 140° C. for 1 to 6 hours.

16. A method for catalyzing a hydrogenation or cyclization reaction, comprising using the catalyst according to claim 1.

17. The method according to claim 16, wherein said catalyst is used for catalyzing the synthesis of hydrogen peroxide.

18. The catalyst according to claim 5, wherein the amount of said catalytically active metal is from 0.1% to 5% by weight, calculated as catalytically active metal in reduced form and based on the total weight of the support material.
